(19) United States
(12) Patent Application Publication
(10) Pub. No.: US 2026/0255180 A1
(43) Pub. Date: Aug. 27, 2026

(54) GENERATING DIGITAL TWINS ASSOCIATED WITH DIFFERENT POINTS IN TIME

(71) Applicant: QUALCOMM Incorporated, San Diego, CA (US)

(72) Inventors: Parag Mohan KANADE, San Diego, CA (US); Satyam GABA, San Diego, CA (US); Lokesh JAIN, San Diego, CA (US); Sony AKKARAKARAN, Poway, CA (US)

(21) Appl. No.: 19/467,577

(22) Filed: Feb. 2, 2026

Related U.S. Application Data
(60) Provisional application No. 63/763,730, filed on Feb. 26, 2025.

(51) Int. Cl. H04W 16/18; G06T 17/05; G06T 19/00

(52) U.S. Cl. CPC H04W 16/18; G06T 17/05; G06T 19/00

(57) ABSTRACT

Methods, systems, and devices for digital twin creation are described. Various aspects relate to digital twin creation that accounts for time-dependent characteristics associated with a geographic area. Some aspects more specifically relate to generating a digital twin associated with a different point in time relative to a point in time at which input map data associated with the geographic coverage area was acquired. A digital twin creation entity may obtain data associated with an original three-dimensional model of the geographic area, with the original three-dimensional model being of the geographic area at a first point in time. The digital twin creation entity may generate an updated three-dimensional model based on a modification of the original three-dimensional model to account for time-dependent characteristics associated with the geographic area. The digital twin creation entity may output a digital twin associated with the geographic area based on the updated three-dimensional model.

### CROSS REFERENCES

The present Application for Patent claims benefit of U.S. Provisional Patent Application No. 63/763,730 by KANADE et al., entitled “GENERATING DIGITAL TWINS ASSOCIATED WITH DIFFERENT POINTS IN TIME,” filed Feb. 26, 2025, assigned to the assignee hereof, and expressly incorporated by reference herein.

### FIELD OF TECHNOLOGY

The following relates to digital twin creation, including generating digital twins associated with different points in time.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for digital twin creation (e.g., by or at an apparatus, a communication device, a digital twin creation entity, a digital twin server, etc.) is described. The method may include obtaining data associated with an original three-dimensional model of a geographic area, where the original three-dimensional model is of the geographic area at a first point in time, generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification, and outputting a digital twin associated with the geographic area based on the updated three-dimensional model of the geographic area that is associated with the second point in time.

An apparatus (e.g., a communication device, a digital twin creation entity, a digital twin server, etc.) for digital twin creation is described. The apparatus may include one or more memories storing processor executable code, and one or more processors coupled with the one or more memories. The one or more processors may individually or collectively be operable to execute the code to cause the apparatus to obtain data associated with an original three-dimensional model of a geographic area, where the original three-dimensional model is of the geographic area at a first point in time, generate an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification, and output a digital twin associated with the geographic area based on the updated three-dimensional model of the geographic area that is associated with the second point in time.

Another apparatus (e.g., a communication device, a digital twin creation entity, a digital twin server, etc.) for digital twin creation is described. The apparatus may include means for obtaining data associated with an original three-dimensional model of a geographic area, where the original three-dimensional model is of the geographic area at a first point in time, means for generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification, and means for outputting a digital twin associated with the geographic area based on the updated three-dimensional model of the geographic area that is associated with the second point in time.

A non-transitory computer-readable medium storing code for digital twin creation is described. The code may include instructions executable by one or more processors to obtain data associated with an original three-dimensional model of a geographic area, where the original three-dimensional model is of the geographic area at a first point in time, generate an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification, and output a digital twin associated with the geographic area based on the updated three-dimensional model of the geographic area that is associated with the second point in time.

Some examples of the method, apparatus, and non-transitory computer-readable medium described herein may further include operations, features, means, or instructions for identifying the one or more time-dependent characteristics associated with the geographic area based on the original three-dimensional model of the geographic area, where the updated three-dimensional model may be generated based on identification of the one or more time-dependent characteristics.

In some examples of the method, apparatus, and non-transitory computer-readable medium described herein, identifying the one or more time-dependent characteristics may include operations, features, means, or instructions for identifying foliage within the geographic area based on the original three-dimensional model of the geographic area and identifying one or more types of the foliage.

In some examples of the method, apparatus, and non-transitory computer-readable medium described herein, identifying the one or more time-dependent characteristics may include operations, features, means, or instructions for identifying one or more construction projects within the geographic area based on the original three-dimensional model of the geographic area.

In some examples of the method, apparatus, and non-transitory computer-readable medium described herein, generating the updated three-dimensional model of the geographic area may include operations, features, means, or instructions for supplementing the original three-dimensional model of the geographic area with one or more three-dimensional models based on the one or more time-dependent characteristics.

In some examples of the method, apparatus, and non-transitory computer-readable medium described herein, generating the updated three-dimensional model of the geographic area may include operations, features, means, or instructions for removing one or more three-dimensional models from the original three-dimensional model of the geographic area based on the one or more time-dependent characteristics.

Some examples of the method, apparatus, and non-transitory computer-readable medium described herein may further include operations, features, means, or instructions for outputting a second digital twin associated with the geographic area based on the original three-dimensional model of the geographic area that may be associated with the first point in time.

Some examples of the method, apparatus, and non-transitory computer-readable medium described herein may further include operations, features, means, or instructions for generating a second updated three-dimensional model of the geographic area based on the one or more time-dependent characteristics associated with the geographic area, where the second updated three-dimensional model of the geographic area may be associated with a third point in time different than the second point in time and outputting a second digital twin associated with the geographic area based on the second updated three-dimensional model of the geographic area that may be associated with the third point in time.

Some examples of the method, apparatus, and non-transitory computer-readable medium described herein may further include operations, features, means, or instructions for detecting a trigger associated with a creation of the digital twin, where the trigger indicates that the digital twin is to be associated with the second point in time, and where the digital twin may be output based on the trigger.

In some examples of the method, apparatus, and non-transitory computer-readable medium described herein, the trigger may be associated with a change in weather at the geographic area.

In some examples of the method, apparatus, and non-transitory computer-readable medium described herein, detecting the trigger may include operations, features, means, or instructions for receiving an indication of the trigger from another entity.

In some examples of the method, apparatus, and non-transitory computer-readable medium described herein, the first point in time may be associated with a first season of a set of multiple seasons including two or more of a set including spring, summer, fall, and winter and the second point in time may be associated with a second season of the set of multiple seasons.

In some examples of the method, apparatus, and non-transitory computer-readable medium described herein, the one or more time-dependent characteristics include at least one of a foliage, a construction project, a calendar date, a length of a day, a hibernation pattern, or a migration pattern.

In some examples of the method, apparatus, and non-transitory computer-readable medium described herein, the one or more time-dependent characteristics may be identified, localized, generated, or any combination thereof in accordance with utilization of computer vision, an AI technique, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports generating digital twins associated with different points in time in accordance with one or more aspects of the present disclosure.

FIG. 2 shows an example of a digital twin creation or refinement procedure that supports generating digital twins associated with different points in time in accordance with one or more aspects of the present disclosure.

FIGS. 3 and 4 show block diagrams of devices that support generating digital twins associated with different points in time in accordance with one or more aspects of the present disclosure.

FIG. 5 shows a block diagram of a digital twin creation entity that supports generating digital twins associated with different points in time in accordance with one or more aspects of the present disclosure.

FIG. 6 shows a diagram of a system including a UE that supports generating digital twins associated with different points in time in accordance with one or more aspects of the present disclosure.

FIG. 7 shows a diagram of a system including a network entity that supports generating digital twins associated with different points in time in accordance with one or more aspects of the present disclosure.

FIGS. 8 and 9 show flowcharts illustrating methods that support generating digital twins associated with different points in time in accordance with one or more aspects of the present disclosure.

### DETAILED DESCRIPTION

Some network operators, controllers, providers, or planners/developers may create and use a digital twin associated with a geographic area to help make decisions, predictions, or estimations associated with a wireless communications system located within the geographic area. As described herein, a geographic area may include an indoor area (e.g., inside a building or structure), an outdoor area, or any combination of one or more indoor areas and one or more outdoor areas. A digital twin associated with a geographic area may enable interested parties to use digital models to (at least approximately) replicate one or more devices, objects, processes, or conditions of the geographic area (or of the wireless communications system) and perform simulations within a virtual representation of the geographic area. In other words, a digital twin associated with a geographic area may be referred to or understood as a virtual environment or a virtual representation of the geographic area and may be used to perform one or more of various simulations. Such simulations performed using the digital twin may provide insight into how devices, objects, processes, or conditions of a real-world version of the geographic area interact or perform, among other examples. For example, a digital twin associated with a geographic area may be used to simulate, predict, or estimate one or more metrics associated with wireless communications within the geographic area. A digital twin creation entity may generate, create, construct, or otherwise output a digital twin. Such a digital twin creation entity may be included within a server or may be or may include one or more servers, one or more processing systems, one or more devices, or any combination thereof, any of which may be collocated or non-collocated. A digital twin creation entity may generate a digital twin based on original input data and may update the digital twin over time.

A digital twin creation entity may use input map data of a geographic area to generate a digital twin. Such input map data may be obtained in accordance with lidar-based techniques, radar-based techniques, or depth camera-based techniques. Additionally, or alternatively, such input map data may include data associated with a three-dimensional model of the geographic area (e.g., obtained from a third-party vendor). Across such various options, the input map data may be based on images or measurements of the geographic area at a particular point in time. For example, lidar-based techniques, radar-based techniques, and depth camera-based techniques may be associated with a relatively large amount of manual labor and, accordingly, may be performed sparingly (e.g., once or relatively infrequently). Similarly, three-dimensional models of some geographic areas may be generated using images taken from one or more aerial devices (e.g., a satellite, a drone, or a low-flying airplane), which may be costly and likewise generated sparingly (e.g., once or relatively infrequently). Some geographic areas, however, may be associated with time-dependent characteristics (e.g., objects or any other characteristics that change, at least in part, over time, such as due to one or more of various factors or events). For example, some geographic areas may include plants that have varying amounts of foliage over time. By way of further example, some geographic areas may include construction projects that may result in a completed (or demolished) building or bridge, among other structures or objects, after the time at which the input map data was obtained. By way of further example, various characteristics associated with a geographic area may be impacted by a natural disaster (or any other event or activity), such that these characteristics also may be understood as time-dependent characteristics due to the change they experience over time (e.g., before and after the natural disaster). Such characteristics may have a material impact on wireless communications within the geographic area. Thus, using a digital twin generated based on out-of-date images or measurements of a geographic area may result in an inaccurate representation of a current version of the geographic area, which may result in inaccurate simulations (e.g., such that simulation results using the digital twin are dissimilar to actual measurements within a real-world version of the geographic area). Thus, digital twin creation and refinement techniques that account for with time-dependent characteristics may be desirable.

Various aspects generally relate to digital twin creation or refinement that accounts for time-dependent characteristics associated with a geographic area. Some aspects more specifically relate to generating a digital twin, for the geographic area, associated with a different point in time relative to a point in time at which input map data associated with the geographic coverage area was acquired. In some examples, a digital twin creation entity may obtain data associated with an original three-dimensional model of the geographic area, with the original three-dimensional model being of the geographic area at a first point in time. The digital twin creation entity may generate an updated three-dimensional model based on a modification of the original three-dimensional model to account for one or more time-dependent characteristics associated with the geographic area. For example, the updated three-dimensional model may be associated with a second point in time (different than the first point in time) in accordance with the modification of the original three-dimensional model. The digital twin creation entity may generate the updated three-dimensional model based on supplementing the original three-dimensional model with a three-dimensional model corresponding to a time-dependent characteristic, removing a three-dimensional model corresponding to a time-dependent characteristic from the original three-dimensional model, or replacing a three-dimensional model of the original three-dimensional model with another three-dimensional model, among other examples. The original three-dimensional model and the updated three-dimensional model may be associated with any three-dimensional representation format including meshes, point clouds, voxels, neural radiance fields, or octree, among other examples. The digital twin creation entity may output a digital twin associated with the geographic area based on the updated three-dimensional model.

Aspects of the subject matter described in this disclosure can be implemented to realize one or more of the following potential advantages. For example, by outputting a digital twin associated with the geographic area that is associated with the second point in time, the digital twin creation entity may keep the digital twin associated with the geographic area up to date with time-dependent characteristics associated with the geographic area. In accordance with keeping the digital twin associated with the geographic area up to date with the time-dependent characteristics, the digital twin may be a more accurate representation of a current version of the geographic area, which may lead to simulation results from the digital twin being more accurate (e.g., more representative or more similar to results obtained from actual measurements or tests within the real-world geographic area). Further, in accordance with the digital twin providing more accurate simulation results, the digital twin may be used to make better decisions, predictions, or estimations associated with wireless communications within the geographic area, which may facilitate greater system capacity, higher data rates, and greater spectral efficiency, among other benefits.

Aspects of the disclosure are initially described in the context of wireless communications systems. Additionally, aspects of the disclosure are illustrated by and described with reference to a digital twin creation or refinement procedure. Aspects of the disclosure are further illustrated by and described with reference to apparatus diagrams, system diagrams, and flowcharts that relate to generating digital twins associated with different points in time.

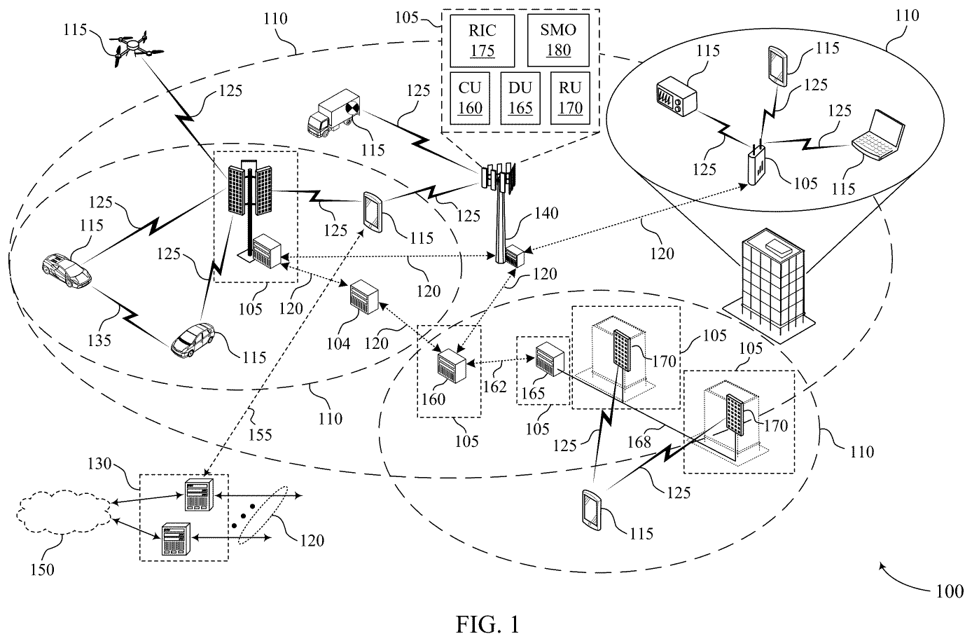

FIG. 1 shows an example of a wireless communications system 100 that supports generating digital twins associated with different points in time in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support generating digital twins associated with different points in time as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be located within a geographic area and, in some cases, a network operator, controller, provider, or planner/developer may create and use a digital twin associated with the geographic area to help make decisions, predictions, or estimations associated with the wireless communications system 100. The network operator, controller, provider, or planner/developer may use the digital twin to model a physical environment in a virtual environment (e.g., a virtual world) and, instead of or in addition to performing measurements or tests within the physical environment, may perform measurements or tests using the model of the physical environment. In other words, a digital twin may be a model of a real-world environment in a virtual world. A digital twin may run any quantity of simulations to study one or multiple processes. A digital twin may have access to near real-time data, such that digital twins may be designed around a two-way flow of information including real-world sensors/measurements (input to a digital twin creation entity) and simulation results (output from the digital twin creation entity).

A digital twin creation entity may generate a digital twin based on a three-dimensional model of a geographic area. Using wireless raytracing and/or artificial intelligence (AI)-based techniques (e.g., AI-based wireless simulation), one or more transmitters and one or more receivers may be placed within the three-dimensional model and RF paths between the one or more transmitters and the one or more receivers may be raytraced to generate data, with such data being usable to perform studies to predict, estimate, or otherwise determine one or more metrics associated with wireless communications within the geographic area. A network operator, controller, provider, or planner/developer may use such data and/or metrics to make decisions associated with a real-world version of the wireless communications system 100, as such data and/or metrics may approximate actual data and/or metrics that might have been obtained if measurements or tests within the physical environment were performed. In other words, a digital twin associated with a geographic area including the wireless communications system 100 may leverage or otherwise involve wireless raytracing to simulate or emulate a performance of the wireless communications system 100.

In some implementations, one or more communication devices, nodes, or entities of the wireless communications system 100 may support techniques associated with digital twin creation that accounts for time-dependent characteristics associated with a geographic area. For example, one or more communication devices, nodes, or entities of the wireless communications system 100 may generate a digital twin, for the geographic area, associated with a different point in time relative to a point in time at which input map data associated with the geographic coverage area was acquired. A point in time at which input map data is acquired may refer to a time at which one or more images or measurements were taken or performed that may then be used to create or generate a three-dimensional model of a geographic area.

As described herein, a digital twin creation entity may create, generate, construct, or otherwise output a digital twin. The digital twin creation entity may be located at or within a network entity 105, a UE 115, or any other node or device associated with the wireless communications system 100. In other words, the digital twin creation entity may be collocated with a network entity 105, a UE 115, or any other node or device associated with the wireless communications system 100. Additionally, or alternatively, the digital twin creation entity may be non-collocated with a network entity 105, a UE 115, or any other node or device associated with the wireless communications system 100. In other words, the digital twin creation entity may be understood as being within a single device or node or distributed across multiple devices or nodes. The digital twin creation entity may be located at or within one or more nodes or devices associated with the core network 130.

In some examples, the digital twin creation entity may obtain data associated with an original three-dimensional model of the geographic area, with the original three-dimensional model being of the geographic area at a first point in time. The digital twin creation entity may generate an updated three-dimensional model based on a modification of the original three-dimensional model to account for one or more time-dependent characteristics associated with the geographic area. For example, the updated three-dimensional model may be associated with a second point in time (different than the first point in time) in accordance with the modification of the original three-dimensional model. The digital twin creation entity may generate the updated three-dimensional model based on supplementing the original three-dimensional model with a three-dimensional model corresponding to a time-dependent characteristic, removing a three-dimensional model corresponding to a time-dependent characteristic from the original three-dimensional model, or replacing a three-dimensional model of the original three-dimensional model with another three-dimensional model, among other examples. The digital twin creation entity may output a digital twin associated with the geographic area based on the updated three-dimensional model.

The digital twin creation entity may obtain the data associated with the original three-dimensional model of the geographic area from a network entity 105, a UE 115, or any other node or device associated with the wireless communications system 100. The digital twin creation entity may output the digital twin to network entity 105, a UE 115, or any other node or device associated with the wireless communications system 100.

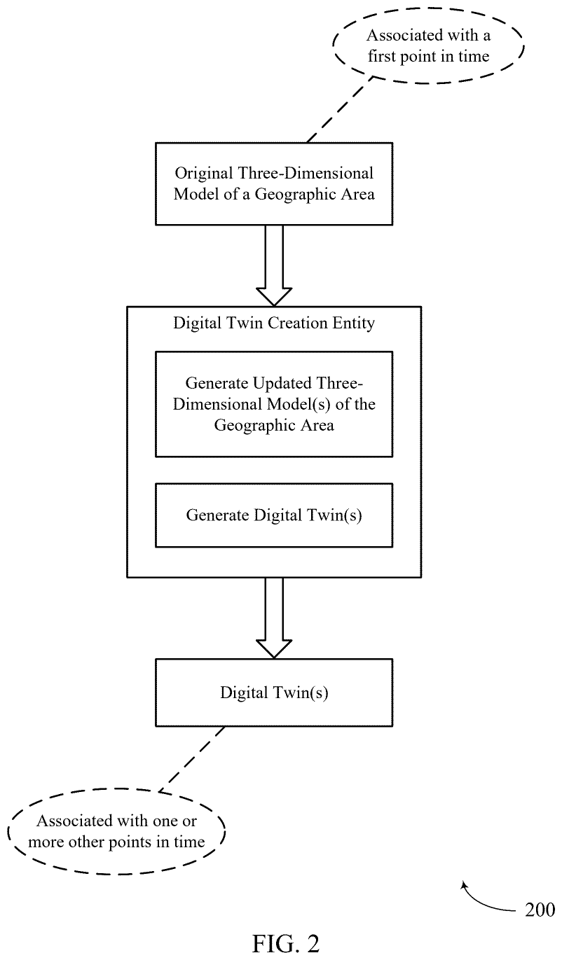

FIG. 2 shows an example of a digital twin creation or refinement procedure 200 that supports generating digital twins associated with different points in time in accordance with one or more aspects of the present disclosure. In accordance with the digital twin creation or refinement procedure 200, a digital twin creation entity may obtain an original three-dimensional model of a geographic area, generate one or more updated three-dimensional models of the geographic area (e.g., based on one or more time-dependent characteristics associated with the geographic area), and generate one or more digital twins associated with the geographic area based on the one or more updated three-dimensional models. The digital twin creation entity may output the one or more digital twins (e.g., to one or more other nodes, entities, servers, memories, or devices).

In some wireless communications systems, one or more characteristics associated with a geographic area may impact wireless communications, such as RF propagation, especially at relatively higher frequencies (e.g., FR2 or FR4 frequencies, among other examples). Such characteristics may include (tree or bush) foliage, structures, or materials of structures, among other examples. In some deployment scenarios, at least some of such characteristics may be time-dependent (e.g., time-varying). For example, some trees or bushes may lose their leaves in fall/winter and grow leaves in spring/summer. By way of further example, some structures may change over time (e.g., in accordance with construction or destruction). By way of further example, a material of some structures may change over time (e.g., windows may be removed or added, a first type of glass may be replaced with another type of glass, moss or other plant life may grow across a surface that was previously bare, among other examples). By way of further example, types of weather may change over time (e.g., snow, rain, or fog may be seasonal). By way of further example, time-dependent characteristics may additionally, or alternatively, include (one or more characteristics that are impacted by) a calendar date, a length of a day (e.g., in terms of time of daylight and/or time of darkness), one or more hibernation patterns, or one or more migration patterns, among other examples. By way of further example, time-dependent characteristics may additionally, or alternatively, include any one or more characteristics associated with a geographic area that are impacted by a natural disaster (e.g., a wildfire, an earthquake, a flood, heavy rainfall, a tornado, a drought, a volcanic eruption, a meteor strike, etc.) or any other activity, event, or time that causes, is associated with, or correlates with a change in the geographic area (e.g., a change in the geographic area that might impact wireless communications).

Accurate modeling of the physical world may be a high priority performance goal associated with generating a digital twin associated with a geographic area. In some cases, however, data from one or more map sources may be available (only) for a particular season (or, more generally, a particular point in time). A digital twin that is created from a map source associated with a particular season or point in time may result in relatively poor performance in different seasons or at later points in time, due to time-dependent characteristics associated with the geographic area. To address such considerations, one or more of the various devices described herein may support techniques to generate one or more digital twins for different seasons based on a single set of input data (associated with a single season or a single point in time). For example, a digital twin creation entity may generate multiple digital twins for different seasons or points in time, which may result in more accurate modeling of a physical environment across the different seasons or different points in time, which may in turn result in higher quality data from the digital twin.

In some implementations, a digital twin creation entity may identify one or more time-dependent characteristics associated with the geographic area. Such one or more time-dependent characteristics may be identified using computer vision, AI techniques, or both, for example (e.g., in some cases, computer vision may be part of a generative AI model). For example, the digital twin creation entity may generate a digital twin for fall/winter from a map source associated with spring/summer. In such examples, the digital twin creation entity may, based on a tree type, remove foliage from one or more two-dimensional images associated with the geographic area. The digital twin creation entity may, using back projection, identify one or more models (e.g., associated with any three-dimensional representation format) corresponding to the foliage. In accordance with identifying the models, the digital twin creation entity may delete (e.g., remove or replace) the models from the three-dimensional model (e.g., an original three-dimensional mode). Although described in the example of identifying foliage and models corresponding to the foliage, such techniques may be equivalently used to identify any other time-dependent characteristics and models corresponding to those time-dependent characteristics.

As part of generating a digital twin for generating a digital twin for fall/winter from spring/summer data, the digital twin creation entity may identify deciduous trees in the original three-dimensional model. The digital twin creation entity may use computer vision, among other techniques such as AI techniques (e.g., generative AI), to identify and localize deciduous trees in the original three-dimensional model. The digital twin creation entity may use computer vision, among other techniques (such as AI techniques), to further localize leaves/foliage of the localized deciduous trees. Additionally, or alternatively, the digital twin creation entity may identify a respective timing of a budburst for each of one or more plant types, a respective timing of flowering for each of one or more plant types, or a respective timing of leaving for each of one or more plant types, among other examples. The digital twin creation entity may delete the models corresponding to the localized foliage (e.g., buds, flowers, leaves, etc.) from the original three-dimensional model. Although described in the context of identifying and localizing deciduous trees, such techniques may be used to identify and localize any other type of plant (to account for plants that otherwise lose their foliage, such as in accordance with a disease, insect, storm, wind, tree/plant pruning or removal, etc.) or any other type of time-dependent characteristic associated with the geographic area.

By way of further example, the digital twin creation entity may generate a digital twin for spring/summer from a map source associated with fall/winter. In such examples, the digital twin creation entity may, based on a tree type, add foliage to one or more two-dimensional images associated with the geographic area. The digital twin creation entity may, using back projection, identify models corresponding to the added foliage and may add the models to the three-dimensional model (e.g., an original three-dimensional mode). Although described in the example of identifying foliage and models corresponding to the foliage, such techniques may be equivalently used to identify any other time-dependent characteristics and models corresponding to those time-dependent characteristics.

As part of generating a digital twin for spring/summer from fall/winter data, the digital twin creation entity may identify deciduous trees in the original three-dimensional model. The digital twin creation entity may use computer vision, among other techniques, to identify and localize deciduous trees as well as the type of tree (e.g., maple, cedar, oak, ash etc.) in the original three-dimensional model. To create the three-dimensional model corresponding to the foliage, the digital twin creation entity may query a database to get the three-dimensional model, may implement a photogrammetry technique, or may extract foliage from a different map source, among other examples. Although described in the context of identifying and localizing deciduous trees, such techniques may be used to identify and localize other types of plants (to account for plants that otherwise gain their foliage, such as in accordance with recovering from a disease, insect, storm, wind, tree/plant pruning or removal, etc.) or any other time-dependent characteristics associated with the geographic area.

Back projection may refer to a technique according to which a three-dimensional model is “imaged” from one or more known virtual camera positions (within the three-dimensional model or within the digital twin) to obtain unsegmented two-dimensional images, according to which the unsegmented two-dimensional images are segmented and labeled to obtain labeled segmented two-dimensional images, and according to which the labeled segmented two-dimensional images are projected back onto the three-dimensional model. In other words, back projection may involve determining an association between points in the three-dimensional model and pixels of a (labeled and segmented) two-dimensional image and according to which the labels of the two-dimensional image are transferred back into the three-dimensional model using the association.

In some implementations, the digital twin creation entity may detect a trigger to generate one or more digital twins for different seasons. In some examples, digital twins for different seasons may be generated based on one or multiple triggers. In some implementations, digital twins for all seasons may be generated at a same time or at approximately a same time (and output from the digital twin creation entity together, such as via a single message or a set of messages sent as a collective). Additionally, or alternatively, a digital twin may be generated based on an indication, such as an indication from another entity. For example, to model changes on a shorter time scale, a digital twin may be updated based on weather. In such examples, a change in weather at the geographic area may trigger the digital twin creation entity to generate a digital twin associated with the updated weather. Such a digital twin may be based on a three-dimensional model that is, for example, updated to include snow on the ground or rain in the air, among other examples.

Further, although described in the context of generating digital twins for different seasons or different types of weather, such triggering techniques may be applicable to generating digital twins to account for any other time-related aspects that may impact one or more time-dependent characteristics associated with the geographic area. For example, a trigger may be associated with an update to or a completion of a construction project, an update to or a completion of a demolition project, a change in a material of a surface, or plant growth. By way of further example, a trigger may be associated with a calendar date, a length of a day (e.g., in terms of time of daylight and/or time of darkness), a hibernation of one or more animals, a bird migration, a natural disaster (e.g., a wildfire, an earthquake, a flood, heavy rainfall, a tornado, a drought, a volcanic eruption, a meteor strike, etc.), or any other activity, event, or time that causes, is associated with, or correlates with a change in a geographic area, among other examples. The digital twin creation entity may detect (e.g., receive an indication of) any one or more of such triggers and generate a digital twin in accordance with the trigger. For example, the digital twin creation entity (and/or a digital twin server) may receive an indication of a natural disaster (along with information associated with an impact by the natural disaster) and may generate a digital twin to account for the impact that the natural disaster had on the geographic area.

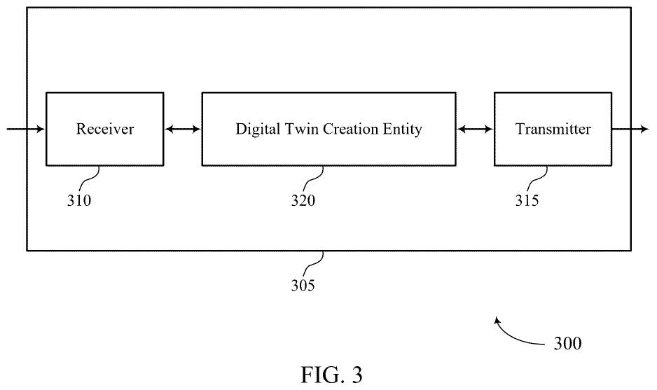

FIG. 3 shows a block diagram 300 of a device 305 that supports generating digital twins associated with different points in time in accordance with one or more aspects of the present disclosure. The device 305 may be an example of aspects of a digital twin server, which may be or be located at a UE 115 or a network entity 105, as described herein. Additionally, or alternatively, the device 305 may include a digital twin server. The device 305 may include a receiver 310, a transmitter 315, and a digital twin creation entity 320. The device 305, or one or more components of the device 305 (e.g., the receiver 310, the transmitter 315, the digital twin creation entity 320), may include at least one processor, which may be coupled with at least one memory, to, individually or collectively, support or enable the described techniques. Each of these components may be in communication with one another (e.g., via one or more buses).

The receiver 310 may provide a means for receiving information such as packets, user data, control information, or any combination thereof associated with various information channels (e.g., control channels, data channels, information channels related to generating digital twins associated with different points in time). Information may be passed on to other components of the device 305. The receiver 310 may utilize a single antenna or a set of multiple antennas.

The transmitter 315 may provide a means for transmitting signals generated by other components of the device 305. For example, the transmitter 315 may transmit information such as packets, user data, control information, or any combination thereof associated with various information channels (e.g., control channels, data channels, information channels related to generating digital twins associated with different points in time). In some examples, the transmitter 315 may be co-located with a receiver 310 in a transceiver module. The transmitter 315 may utilize a single antenna or a set of multiple antennas.

The digital twin creation entity 320, the receiver 310, the transmitter 315, or various combinations or components thereof may be examples of means for performing various aspects of generating digital twins associated with different points in time as described herein. For example, the digital twin creation entity 320, the receiver 310, the transmitter 315, or various combinations or components thereof may be capable of performing one or more of the functions described herein.

In some examples, the digital twin creation entity 320, the receiver 310, the transmitter 315, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the digital twin creation entity 320, the receiver 310, the transmitter 315, or various combinations or components thereof may be implemented in code (e.g., as communications management software or firmware) executed by at least one processor (e.g., referred to as a processor-executable code). If implemented in code executed by at least one processor, the functions of the digital twin creation entity 320, the receiver 310, the transmitter 315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the digital twin creation entity 320 may be configured to perform various operations (e.g., receiving, obtaining, monitoring, outputting, transmitting) using or otherwise in cooperation with the receiver 310, the transmitter 315, or both. For example, the digital twin creation entity 320 may receive information from the receiver 310, send information to the transmitter 315, or be integrated in combination with the receiver 310, the transmitter 315, or both to obtain information, output information, or perform various other operations as described herein.

The digital twin creation entity 320 may support digital twin creation in accordance with examples as disclosed herein. For example, the digital twin creation entity 320 is capable of, configured to, or operable to support a means for obtaining data associated with an original three-dimensional model of a geographic area, where the original three-dimensional model is of the geographic area at a first point in time. The digital twin creation entity 320 is capable of, configured to, or operable to support a means for generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification. The digital twin creation entity 320 is capable of, configured to, or operable to support a means for outputting a digital twin associated with the geographic area based on the updated three-dimensional model of the geographic area that is associated with the second point in time.

By including or configuring the digital twin creation entity 320 in accordance with examples as described herein, the device 305 (e.g., at least one processor controlling or otherwise coupled with the receiver 310, the transmitter 315, the digital twin creation entity 320, or a combination thereof) may support techniques for creating or refining a digital twin such that the digital twin is an accurate representation of a real-world version of a geographic area.

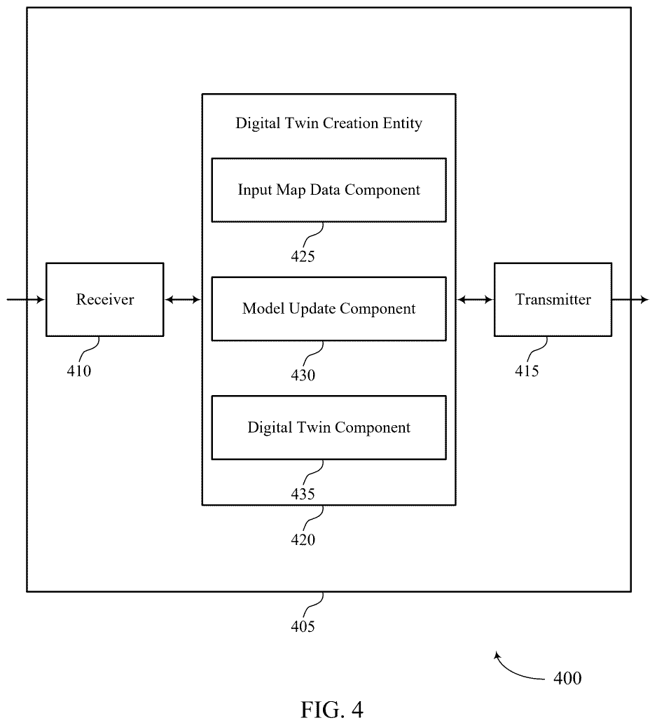

FIG. 4 shows a block diagram 400 of a device 405 that supports generating digital twins associated with different points in time in accordance with one or more aspects of the present disclosure. The device 405 may be an example of aspects of a device 305, a digital twin server, a UE 115, or a network entity 105 as described herein. Additionally, or alternatively, the device 405 may include a digital twin server. The device 405 may include a receiver 410, a transmitter 415, and a digital twin creation entity 420. The device 405, or one or more components of the device 405 (e.g., the receiver 410, the transmitter 415, the digital twin creation entity 420), may include at least one processor, which may be coupled with at least one memory, to support the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to generating digital twins associated with different points in time). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to generating digital twins associated with different points in time). In some examples, the transmitter 415 may be co-located with a receiver 410 in a transceiver module. The transmitter 415 may utilize a single antenna or a set of multiple antennas.

The device 405, or various components thereof, may be an example of means for performing various aspects of generating digital twins associated with different points in time as described herein. For example, the digital twin creation entity 420 may include an input map data component 425, a model update component 430, a digital twin component 435, or any combination thereof. The digital twin creation entity 420 may be an example of aspects of a digital twin creation entity 320 as described herein. In some examples, the digital twin creation entity 420, or various components thereof, may be configured to perform various operations (e.g., receiving, obtaining, monitoring, outputting, transmitting) using or otherwise in cooperation with the receiver 410, the transmitter 415, or both. For example, the digital twin creation entity 420 may receive information from the receiver 410, send information to the transmitter 415, or be integrated in combination with the receiver 410, the transmitter 415, or both to obtain information, output information, or perform various other operations as described herein.

The digital twin creation entity 420 may support digital twin creation in accordance with examples as disclosed herein. The input map data component 425 is capable of, configured to, or operable to support a means for obtaining data associated with an original three-dimensional model of a geographic area, where the original three-dimensional model is of the geographic area at a first point in time. The model update component 430 is capable of, configured to, or operable to support a means for generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification. The digital twin component 435 is capable of, configured to, or operable to support a means for outputting a digital twin associated with the geographic area based on the updated three-dimensional model of the geographic area that is associated with the second point in time.

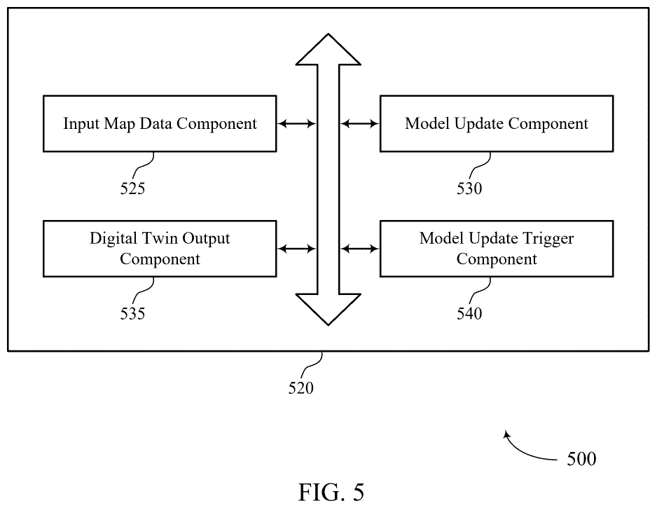

FIG. 5 shows a block diagram 500 of a digital twin creation entity 520 that supports generating digital twins associated with different points in time in accordance with one or more aspects of the present disclosure. The digital twin creation entity 520 may be an example of aspects of a digital twin creation entity 320, a digital twin creation entity 420, or both, as described herein. The digital twin creation entity 520, or various components thereof, may be an example of means for performing various aspects of generating digital twins associated with different points in time as described herein. For example, the digital twin creation entity 520 may include an input map data component 525, a model update component 530, a digital twin output component 535, a model update trigger component 540, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The digital twin creation entity 520 may support digital twin creation in accordance with examples as disclosed herein. The input map data component 525 is capable of, configured to, or operable to support a means for obtaining data associated with an original three-dimensional model of a geographic area, where the original three-dimensional model is of the geographic area at a first point in time. The model update component 530 is capable of, configured to, or operable to support a means for generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification. The digital twin output component 535 is capable of, configured to, or operable to support a means for outputting a digital twin associated with the geographic area based on the updated three-dimensional model of the geographic area that is associated with the second point in time.

In some examples, the model update component 530 is capable of, configured to, or operable to support a means for identifying the one or more time-dependent characteristics associated with the geographic area based on the original three-dimensional model of the geographic area, where the updated three-dimensional model is generated based on identification of the one or more time-dependent characteristics.

In some examples, to support identifying the one or more time-dependent characteristics, the model update component 530 is capable of, configured to, or operable to support a means for identifying foliage within the geographic area based on the original three-dimensional model of the geographic area. In some examples, to support identifying the one or more time-dependent characteristics, the model update component 530 is capable of, configured to, or operable to support a means for identifying one or more types of the foliage.

In some examples, to support identifying the one or more time-dependent characteristics, the model update component 530 is capable of, configured to, or operable to support a means for identifying one or more construction projects within the geographic area based on the original three-dimensional model of the geographic area.

In some examples, to support generating the updated three-dimensional model of the geographic area, the model update component 530 is capable of, configured to, or operable to support a means for supplementing the original three-dimensional model of the geographic area with one or more three-dimensional models based on the one or more time-dependent characteristics.

In some examples, to support generating the updated three-dimensional model of the geographic area, the model update component 530 is capable of, configured to, or operable to support a means for removing one or more three-dimensional models from the original three-dimensional model of the geographic area based on the one or more time-dependent characteristics.

In some examples, the digital twin output component 535 is capable of, configured to, or operable to support a means for outputting a second digital twin associated with the geographic area based on the original three-dimensional model of the geographic area that is associated with the first point in time.

In some examples, the model update component 530 is capable of, configured to, or operable to support a means for generating a second updated three-dimensional model of the geographic area based on the one or more time-dependent characteristics associated with the geographic area, where the second updated three-dimensional model of the geographic area is associated with a third point in time different than the second point in time. In some examples, the digital twin output component 535 is capable of, configured to, or operable to support a means for outputting a second digital twin associated with the geographic area based on the second updated three-dimensional model of the geographic area that is associated with the third point in time.

In some examples, the model update trigger component 540 is capable of, configured to, or operable to support a means for detecting a trigger associated with a creation of the digital twin, where the trigger indicates that the digital twin is to be associated with the second point in time, and where the digital twin is output based on the trigger.

In some examples, the trigger is associated with a change in weather at the geographic area.

In some examples, to support detecting the trigger, the model update trigger component 540 is capable of, configured to, or operable to support a means for receiving an indication of the trigger from another entity.

In some examples, the first point in time is associated with a first season of a set of multiple seasons including two or more of a set including spring, summer, fall, and winter. In some examples, the second point in time is associated with a second season of the set of multiple seasons.

In some examples, the one or more time-dependent characteristics include at least one of a foliage, a construction project, a calendar date, a length of a day, a hibernation pattern, or a migration pattern.

In some examples, the one or more time-dependent characteristics are identified, localized, generated, or any combination thereof in accordance with utilization of computer vision, an AI technique, or both.

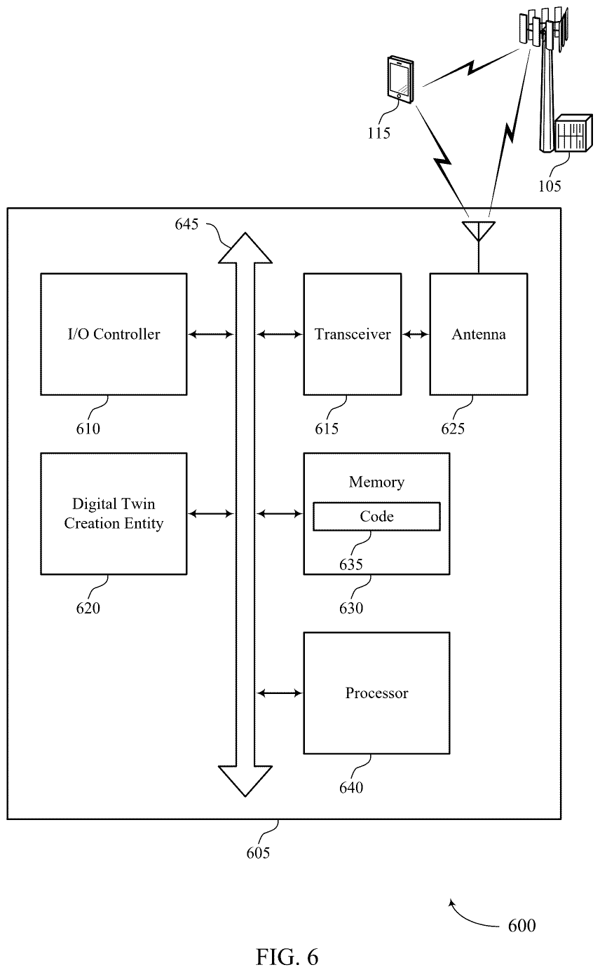

FIG. 6 shows a diagram of a system 600 including a device 605 that supports generating digital twins associated with different points in time in accordance with one or more aspects of the present disclosure. The device 605 may be an example of or include components of a device 305, a device 405, or a UE 115 as described herein. The device 605 may communicate (e.g., wirelessly) with one or more other devices (e.g., network entities 105, UEs 115, or a combination thereof). The device 605 may include components for bi-directional voice and data communications including components for transmitting and receiving communications, such as a digital twin creation entity 620, an input/output (I/O) controller, such as an I/O controller 610, a transceiver 615, one or more antennas 625, at least one memory 630, code 635, and at least one processor 640. These components may be in electronic communication or otherwise coupled (e.g., operatively, communicatively, functionally, electronically, electrically) via one or more buses (e.g., a bus 645).

The I/O controller 610 may manage input and output signals for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some cases, the I/O controller 610 may be implemented as part of one or more processors, such as the at least one processor 640. In some cases, a user may interact with the device 605 via the I/O controller 610 or via hardware components controlled by the I/O controller 610.

In some cases, the device 605 may include a single antenna. However, in some other cases, the device 605 may have more than one antenna, which may be capable of concurrently transmitting or receiving multiple wireless transmissions. The transceiver 615 may communicate bi-directionally via the one or more antennas 625 using wired or wireless links as described herein. For example, the transceiver 615 may represent a wireless transceiver and may communicate bi-directionally with another wireless transceiver. The transceiver 615 may also include a modem to modulate the packets, to provide the modulated packets to one or more antennas 625 for transmission, and to demodulate packets received from the one or more antennas 625. The transceiver 615, or the transceiver 615 and one or more antennas 625, may be an example of a transmitter 315, a transmitter 415, a receiver 310, a receiver 410, or any combination thereof or component thereof, as described herein.

The at least one memory 630 may include random access memory (RAM) and read-only memory (ROM). The at least one memory 630 may store computer-readable, computer-executable, or processor-executable code, such as the code 635. The code 635 may include instructions that, when executed by the at least one processor 640, cause the device 605 to perform various functions described herein. The code 635 may be stored in a non-transitory computer-readable medium such as system memory or another type of memory. In some cases, the code 635 may not be directly executable by the at least one processor 640 but may cause a computer (e.g., when compiled and executed) to perform functions described herein. In some cases, the at least one memory 630 may include, among other things, a basic I/O system (BIOS) which may control basic hardware or software operation such as the interaction with peripheral components or devices.

The at least one processor 640 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 640 may be configured to operate a memory array using a memory controller. In some other cases, a memory controller may be integrated into the at least one processor 640. The at least one processor 640 may be configured to execute computer-readable instructions stored in a memory (e.g., the at least one memory 630) to cause the device 605 to perform various functions (e.g., functions or tasks supporting generating digital twins associated with different points in time). For example, the device 605 or a component of the device 605 may include at least one processor 640 and at least one memory 630 coupled with or to the at least one processor 640, the at least one processor 640 and the at least one memory 630 configured to perform various functions described herein.

In some examples, the at least one processor 640 may include multiple processors and the at least one memory 630 may include multiple memories. One or more of the multiple processors may be coupled with one or more of the multiple memories, which may, individually or collectively, be configured to perform various functions described herein. In some examples, the at least one processor 640 may be a component of a processing system, which may refer to a system (such as a series) of machines, circuitry (including, for example, one or both of processor circuitry (which may include the at least one processor 640) and memory circuitry (which may include the at least one memory 630)), or components, that receives or obtains inputs and processes the inputs to produce, generate, or obtain a set of outputs. The processing system may be configured to perform one or more of the functions described herein. For example, the at least one processor 640 or a processing system including the at least one processor 640 may be configured to, configurable to, or operable to cause the device 605 to perform one or more of the functions described herein. Further, as described herein, being “configured to,” being “configurable to,” and being “operable to” may be used interchangeably and may be associated with a capability, when executing code 635 (e.g., processor-executable code) stored in the at least one memory 630 or otherwise, to perform one or more of the functions described herein.

The digital twin creation entity 620 may support digital twin creation in accordance with examples as disclosed herein. For example, the digital twin creation entity 620 is capable of, configured to, or operable to support a means for obtaining data associated with an original three-dimensional model of a geographic area, where the original three-dimensional model is of the geographic area at a first point in time. The digital twin creation entity 620 is capable of, configured to, or operable to support a means for generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification. The digital twin creation entity 620 is capable of, configured to, or operable to support a means for outputting a digital twin associated with the geographic area based on the updated three-dimensional model of the geographic area that is associated with the second point in time.

By including or configuring the digital twin creation entity 620 in accordance with examples as described herein, the device 605 may support techniques for creating or refining a digital twin such that the digital twin is an accurate representation of a real-world version of a geographic area.

In some examples, the digital twin creation entity 620 may be configured to perform various operations (e.g., receiving, monitoring, transmitting) using or otherwise in cooperation with the transceiver 615, the one or more antennas 625, or any combination thereof. Although the digital twin creation entity 620 is illustrated as a separate component, in some examples, one or more functions described with reference to the digital twin creation entity 620 may be supported by or performed by the at least one processor 640, the at least one memory 630, the code 635, or any combination thereof. For example, the code 635 may include instructions executable by the at least one processor 640 to cause the device 605 to perform various aspects of generating digital twins associated with different points in time as described herein, or the at least one processor 640 and the at least one memory 630 may be otherwise configured to, individually or collectively, perform or support such operations.

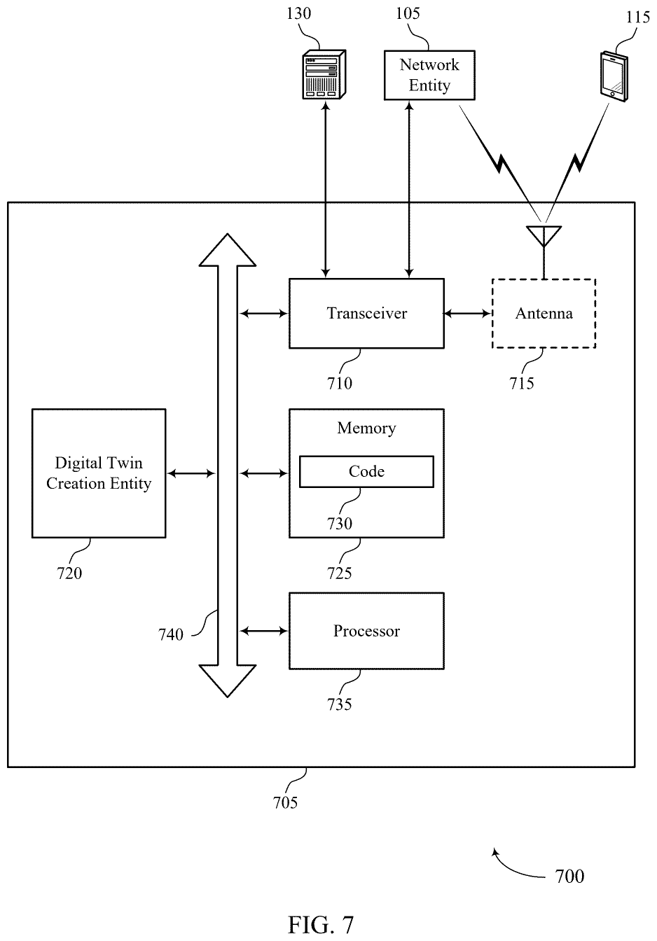

FIG. 7 shows a diagram of a system 700 including a device 705 that supports generating digital twins associated with different points in time in accordance with one or more aspects of the present disclosure. The device 705 may be an example of or include components of a device 305, a device 405, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a digital twin creation entity 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting generating digital twins associated with different points in time). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the digital twin creation entity 720, the transceiver 710, the at least one memory 725, the code 730, and the at least one processor 735 may be located in one of the different components or divided between different components).

In some examples, the digital twin creation entity 720 may manage aspects of communications with a core network 130 (e.g., via one or more wired or wireless backhaul links). For example, the digital twin creation entity 720 may manage the transfer of data communications for client devices, such as one or more UEs 115. In some examples, the digital twin creation entity 720 may manage communications with one or more other network entities 105, and may include a controller or scheduler for controlling communications with UEs 115 (e.g., in cooperation with the one or more other network devices). In some examples, the digital twin creation entity 720 may support an X2 interface within an LTE/LTE-A wireless communications network technology to provide communication between network entities 105.

The digital twin creation entity 720 may support digital twin creation in accordance with examples as disclosed herein. For example, the digital twin creation entity 720 is capable of, configured to, or operable to support a means for obtaining data associated with an original three-dimensional model of a geographic area, where the original three-dimensional model is of the geographic area at a first point in time. The digital twin creation entity 720 is capable of, configured to, or operable to support a means for generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification. The digital twin creation entity 720 is capable of, configured to, or operable to support a means for outputting a digital twin associated with the geographic area based on the updated three-dimensional model of the geographic area that is associated with the second point in time.

By including or configuring the digital twin creation entity 720 in accordance with examples as described herein, the device 705 may support techniques for creating or refining a digital twin such that the digital twin is an accurate representation of a real-world version of a geographic area.

In some examples, the digital twin creation entity 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the digital twin creation entity 720 is illustrated as a separate component, in some examples, one or more functions described with reference to the digital twin creation entity 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of generating digital twins associated with different points in time as described herein, or the at least one processor 735 and the at least one memory 725 may be otherwise configured to, individually or collectively, perform or support such operations.

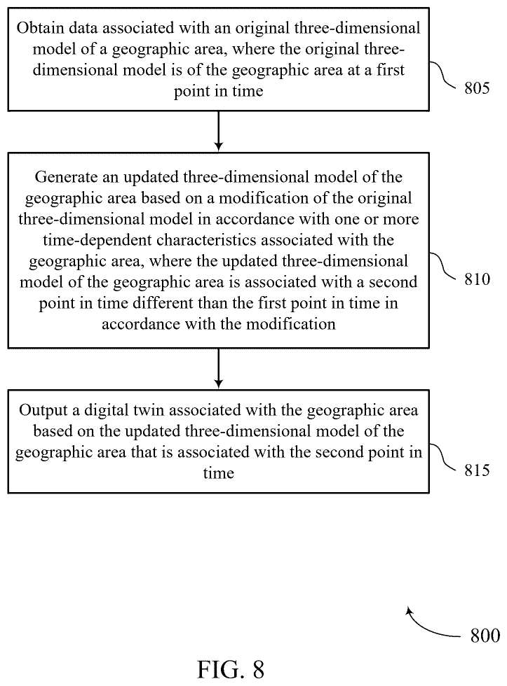

FIG. 8 shows a flowchart illustrating a method 800 that supports generating digital twins associated with different points in time in accordance with one or more aspects of the present disclosure. The operations of the method 800 may be implemented by a UE or a network entity or its components as described herein. For example, the operations of the method 800 may be performed by a UE 115 or a network entity as described with reference to FIGS. 1 through 7. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 805, the method may include obtaining data associated with an original three-dimensional model of a geographic area, where the original three-dimensional model is of the geographic area at a first point in time. The operations of 805 may be performed in accordance with examples as disclosed herein. In some examples, aspects of the operations of 805 may be performed by an input map data component 525 as described with reference to FIG. 5.

At 810, the method may include generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification. The operations of 810 may be performed in accordance with examples as disclosed herein. In some examples, aspects of the operations of 810 may be performed by a model update component 530 as described with reference to FIG. 5.

At 815, the method may include outputting a digital twin associated with the geographic area based on the updated three-dimensional model of the geographic area that is associated with the second point in time. The operations of 815 may be performed in accordance with examples as disclosed herein. In some examples, aspects of the operations of 815 may be performed by a digital twin output component 535 as described with reference to FIG. 5.

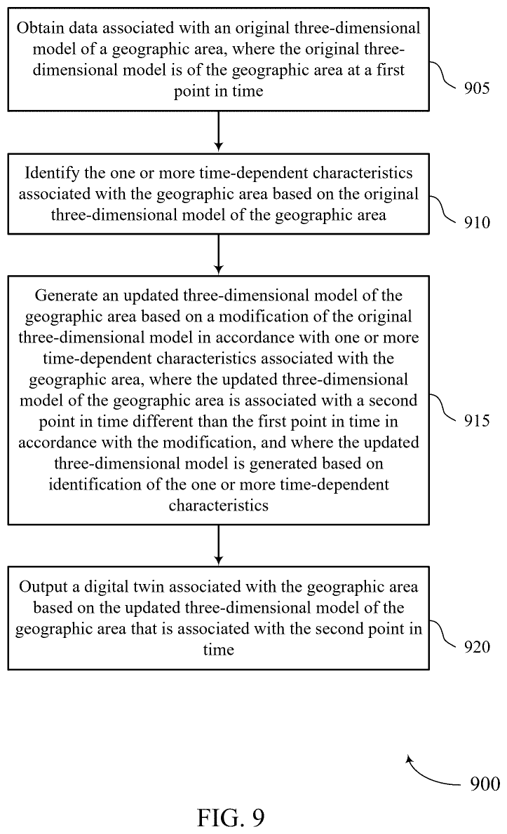

FIG. 9 shows a flowchart illustrating a method 900 that supports generating digital twins associated with different points in time in accordance with one or more aspects of the present disclosure. The operations of the method 900 may be implemented by a UE or a network entity or its components as described herein. For example, the operations of the method 900 may be performed by a UE 115 or a network entity as described with reference to FIGS. 1 through 7. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 905, the method may include obtaining data associated with an original three-dimensional model of a geographic area, where the original three-dimensional model is of the geographic area at a first point in time. The operations of 905 may be performed in accordance with examples as disclosed herein. In some examples, aspects of the operations of 905 may be performed by an input map data component 525 as described with reference to FIG. 5.

At 910, the method may include identifying the one or more time-dependent characteristics associated with the geographic area based on the original three-dimensional model of the geographic area. The operations of 910 may be performed in accordance with examples as disclosed herein. In some examples, aspects of the operations of 910 may be performed by a model update component 530 as described with reference to FIG. 5.

At 915, the method may include generating an updated three-dimensional model of the geographic area based on a modification of the original three-dimensional model in accordance with one or more time-dependent characteristics associated with the geographic area, where the updated three-dimensional model of the geographic area is associated with a second point in time different than the first point in time in accordance with the modification, and where the updated three-dimensional model is generated based on identification of the one or more time-dependent characteristics. The operations of 915 may be performed in accordance with examples as disclosed herein. In some examples, aspects of the operations of 915 may be performed by a model update component 530 as described with reference to FIG. 5.

At 920, the method may include outputting a digital twin associated with the geographic area based on the updated three-dimensional model of the geographic area that is associated with the second point in time. The operations of 920 may be performed in accordance with examples as disclosed herein. In some examples, aspects of the operations of 920 may be performed by a digital twin output component 535 as described with reference to FIG. 5.

The following provides an overview of aspects of the present disclosure:
Aspect 1: A method for digital twin creation, comprising: obtaining data associated with an original three-dimensional model of a geographic area, wherein the original three-dimensional model is of the geographic area at a first point in time; generating an updated three-dimensional model of the geographic area based at least in part on a modification of the original three-dimensional model in accordance with one or more time-dependent characteristics associated with the geographic area, wherein the updated three-dimensional model of the geographic area is associated with a second point in time different than the first point in time in accordance with the modification; and outputting a digital twin associated with the geographic area based at least in part on the updated three-dimensional model of the geographic area that is associated with the second point in time.
Aspect 2: The method of aspect 1, further comprising: identifying the one or more time-dependent characteristics associated with the geographic area based at least in part on the original three-dimensional model of the geographic area, wherein the updated three-dimensional model is generated based at least in part on identification of the one or more time-dependent characteristics.
Aspect 3: The method of aspect 2, wherein identifying the one or more time-dependent characteristics comprises: identifying foliage within the geographic area based at least in part on the original three-dimensional model of the geographic area; and identifying one or more types of the foliage.
Aspect 4: The method of any of aspects 2 through 3, wherein identifying the one or more time-dependent characteristics comprises: identifying one or more construction projects within the geographic area based at least in part on the original three-dimensional model of the geographic area.
Aspect 5: The method of any of aspects 1 through 4, wherein generating the updated three-dimensional model of the geographic area comprises: supplementing the original three-dimensional model of the geographic area with one or more three-dimensional models based at least in part on the one or more time-dependent characteristics.
Aspect 6: The method of any of aspects 1 through 5, wherein generating the updated three-dimensional model of the geographic area comprises: removing one or more three-dimensional models from the original three-dimensional model of the geographic area based at least in part on the one or more time-dependent characteristics.
Aspect 7: The method of any of aspects 1 through 6, further comprising: outputting a second digital twin associated with the geographic area based at least in part on the original three-dimensional model of the geographic area that is associated with the first point in time.
Aspect 8: The method of any of aspects 1 through 7, further comprising: generating a second updated three-dimensional model of the geographic area based at least in part on the one or more time-dependent characteristics associated with the geographic area, wherein the second updated three-dimensional model of the geographic area is associated with a third point in time different than the second point in time; and outputting a second digital twin associated with the geographic area based at least in part on the second updated three-dimensional model of the geographic area that is associated with the third point in time.
Aspect 9: The method of any of aspects 1 through 8, further comprising: detecting a trigger associated with a creation of the digital twin, wherein the trigger indicates that the digital twin is to be associated with the second point in time, and wherein the digital twin is output based at least in part on the trigger.
Aspect 10: The method of aspect 9, wherein the trigger is associated with a change in weather at the geographic area.
Aspect 11: The method of any of aspects 9 through 10, wherein detecting the trigger comprises: receiving an indication of the trigger from another entity.
Aspect 12: The method of any of aspects 1 through 11, wherein the first point in time is associated with a first season of a plurality of seasons comprising two or more of a set including spring, summer, fall, and winter; and the second point in time is associated with a second season of the plurality of seasons.
Aspect 13: The method of any of aspects 1 through 12, wherein the one or more time-dependent characteristics comprise at least one of a foliage, a construction project, a calendar date, a length of a day, a hibernation pattern, or a migration pattern.
Aspect 14: The method of any of aspects 1 through 13, wherein the one or more time-dependent characteristics are identified, localized, generated, or any combination thereof in accordance with utilization of computer vision, an AI technique, or both.
Aspect 15: An apparatus for digital twin creation, comprising one or more memories storing processor-executable code, and one or more processors coupled with the one or more memories and individually or collectively operable to execute the code to cause the apparatus to perform a method of any of aspects 1 through 14.
Aspect 16: An apparatus for digital twin creation, comprising at least one means for performing a method of any of aspects 1 through 14.
Aspect 17: A non-transitory computer-readable medium storing code for digital twin creation, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
obtain data associated with an original three-dimensional model of a geographic area, wherein the original three-dimensional model is of the geographic area at a first point in time;
generate an updated three-dimensional model of the geographic area based at least in part on a modification of the original three-dimensional model in accordance with one or more time-dependent characteristics associated with the geographic area, wherein the updated three-dimensional model of the geographic area is associated with a second point in time different than the first point in time in accordance with the modification; and
output a digital twin associated with the geographic area based at least in part on the updated three-dimensional model of the geographic area that is associated with the second point in time.

2. The apparatus of claim 1, wherein the one or more processors are individually or collectively further operable to execute the code to cause the apparatus to:
identify the one or more time-dependent characteristics associated with the geographic area based at least in part on the original three-dimensional model of the geographic area, wherein the updated three-dimensional model is generated based at least in part on identification of the one or more time-dependent characteristics.

3. The apparatus of claim 2, wherein, to identify the one or more time-dependent characteristics, the one or more processors are individually or collectively operable to execute the code to cause the apparatus to:
identify foliage within the geographic area based at least in part on the original three-dimensional model of the geographic area; and
identify one or more types of the foliage.

4. The apparatus of claim 2, wherein, to identify the one or more time-dependent characteristics, the one or more processors are individually or collectively operable to execute the code to cause the apparatus to:
identify one or more construction projects within the geographic area based at least in part on the original three-dimensional model of the geographic area.

5. The apparatus of claim 1, wherein, to generate the updated three-dimensional model of the geographic area, the one or more processors are individually or collectively operable to execute the code to cause the apparatus to:
supplement the original three-dimensional model of the geographic area with one or more three-dimensional models based at least in part on the one or more time-dependent characteristics.

6. The apparatus of claim 1, wherein, to generate the updated three-dimensional model of the geographic area, the one or more processors are individually or collectively operable to execute the code to cause the apparatus to:
remove one or more three-dimensional models from the original three-dimensional model of the geographic area based at least in part on the one or more time-dependent characteristics.

7. The apparatus of claim 1, wherein the one or more processors are individually or collectively further operable to execute the code to cause the apparatus to:
output a second digital twin associated with the geographic area based at least in part on the original three-dimensional model of the geographic area that is associated with the first point in time.

8. The apparatus of claim 1, wherein the one or more processors are individually or collectively further operable to execute the code to cause the apparatus to:
generate a second updated three-dimensional model of the geographic area based at least in part on the one or more time-dependent characteristics associated with the geographic area, wherein the second updated three-dimensional model of the geographic area is associated with a third point in time different than the second point in time; and
output a second digital twin associated with the geographic area based at least in part on the second updated three-dimensional model of the geographic area that is associated with the third point in time.

9. The apparatus of claim 1, wherein the one or more processors are individually or collectively further operable to execute the code to cause the apparatus to:
detect a trigger associated with a creation of the digital twin, wherein the trigger indicates that the digital twin is to be associated with the second point in time, and wherein the digital twin is output based at least in part on the trigger.

10. The apparatus of claim 9, wherein the trigger is associated with a change in weather at the geographic area.

11. The apparatus of claim 9, wherein, to detect the trigger, the one or more processors are individually or collectively operable to execute the code to cause the apparatus to:
receive an indication of the trigger from another entity.

12. The apparatus of claim 1, wherein:
the first point in time is associated with a first season of a plurality of seasons comprising two or more of a set including spring, summer, fall, and winter; and
the second point in time is associated with a second season of the plurality of seasons.

13. The apparatus of claim 1, wherein the one or more time-dependent characteristics comprise at least one of a foliage, a construction project, a calendar date, a length of a day, a hibernation pattern, or a migration pattern.

14. The apparatus of claim 1, wherein the one or more time-dependent characteristics are identified, localized, generated, or any combination thereof in accordance with utilization of computer vision, an AI technique, or both.

15. A method for digital twin creation, comprising:
obtaining data associated with an original three-dimensional model of a geographic area, wherein the original three-dimensional model is of the geographic area at a first point in time;
generating an updated three-dimensional model of the geographic area based at least in part on a modification of the original three-dimensional model in accordance with one or more time-dependent characteristics associated with the geographic area, wherein the updated three-dimensional model of the geographic area is associated with a second point in time different than the first point in time in accordance with the modification; and
outputting a digital twin associated with the geographic area based at least in part on the updated three-dimensional model of the geographic area that is associated with the second point in time.

16. The method of claim 15, further comprising:
identifying the one or more time-dependent characteristics associated with the geographic area based at least in part on the original three-dimensional model of the geographic area, wherein the updated three-dimensional model is generated based at least in part on identification of the one or more time-dependent characteristics.

17. The method of claim 16, wherein identifying the one or more time-dependent characteristics comprises:
identifying foliage within the geographic area based at least in part on the original three-dimensional model of the geographic area; and
identifying one or more types of the foliage.

18. The method of claim 16, wherein identifying the one or more time-dependent characteristics comprises:
identifying one or more construction projects within the geographic area based at least in part on the original three-dimensional model of the geographic area.

19. The method of claim 15, wherein generating the updated three-dimensional model of the geographic area comprises:
supplementing the original three-dimensional model of the geographic area with one or more three-dimensional models based at least in part on the one or more time-dependent characteristics.

20. A non-transitory computer-readable medium storing code for digital twin creation, the code comprising instructions executable by one or more processors to:
obtain data associated with an original three-dimensional model of a geographic area, wherein the original three-dimensional model is of the geographic area at a first point in time;
generate an updated three-dimensional model of the geographic area based at least in part on a modification of the original three-dimensional model in accordance with one or more time-dependent characteristics associated with the geographic area, wherein the updated three-dimensional model of the geographic area is associated with a second point in time different than the first point in time in accordance with the modification; and
output a digital twin associated with the geographic area based at least in part on the updated three-dimensional model of the geographic area that is associated with the second point in time.
